(19) United States
(12) Patent Application Publication
(10) Pub. No.: US 2017/0152601 A1
(43) Pub. Date: Jun. 1, 2017

(54) POWDER FOR COLD SPRAY, METHOD FOR MANUFACTURING MACROMOLECULAR COATING FILM, AND MACROMOLECULAR COATING FILM

(71) Applicant: INSTITUT NATIONAL DES SCIENCES APPLIQUEES DE LYON, Villeurbanne (FR)

(72) Inventors: Jean-Yves CAVAILLE, Lyon (FR); Olivier LAME, Lyon (FR); Tiana DEPLANCKE, Grenoble (FR); Kazuhiro OGAWA, Natori-city (JP); Ravi KESAVAN, Villeurbanne (FR)

(73) Assignee: INSTITUT NATIONAL DES SCIENCES APPLIQUEES DE LYON, Villeurbanne (FR)

(21) Appl. No.: 15/315,181

(22) PCT Filed: Jun. 2, 2015
(86) PCT No.: PCT/EP2015/062244

§ 371 Date: Nov. 30, 2016

(30) Foreign Application Priority Data
Jun. 2, 2014 (JP) 2014-114361

(51) Int. Cl. C23C 24/04; C09D 123/06; C09D 7/12; C08K 3/22

(52) U.S. Cl. CPC C23C 24/04; C08K 3/22; C09D 123/06; C09D 7/1216; C08K 2003/2227

(57) ABSTRACT

Powder for cold spray containing a mixture of powder of a macromolecule and nanoparticles of a ceramic. Macromolecular coating film containing a mixture of powder of a macromolecule and nanoparticles of a ceramic.

The present invention relates to powder for cold spray, a macromolecular coating film and a method for manufacturing a macromolecular coating film.

As a method for forming a coating film on the surface of a base material, a cold spray method or a melt-spraying method has been known. In the cold spray method, an unoxidized coating film is formed by making powder-form particles in a solid phase collide with a base material at a temperature equal to or lower than the melting point of the particles and, compared with the melt-spraying method, the film formation rate is higher and the thermal alteration of particles can be suppressed.

As a method for manufacturing a macromolecular coating film by forming a film of a macromolecular polymer material on a base material using a cold spray method, there is a method in which polycarbonate particles is used to form a film on a base material (for example, refer to Kazuhiro OGAWA, “The Development of a Polymer Film Using a Cold Spray Method”, Journal of the Japan Welding Society, 2013, Vol. 82, Issue. 8, pp. 5 to 8) or a method in which a film of a preceramic polymer is formed on a base material (for example, refer to US2009/0202732). In addition, a method in which fine-grained metal material particles including a polymer material are used to form a film on a polymer base material using a cold spray method has also been developed (for example, refer to WO2006/063469).

A technique that forms a film of an ultrahigh molecular weight polyethylene on a base material using a warm spaying method in which a film is formed at a temperature higher than that in the cold spray method has also been developed (for example, refer to Seiji KURODA, “The Basic and Application of the Warm Spraying Method”, SOKEIZAI, 2010, Vol. 51, No. 6, pp 14 to 19).

However, in the method for manufacturing a macromolecular coating film described in US2009/0202732, there is a problem in that the thickness of a film being formed is in a range of approximately several tens of micrometers to several hundreds of micrometers, which is extremely thin. Regarding the method for manufacturing a macromolecular coating film described in US2009/0202732, there is no disclosure about the results of actual film formation and it is not possible to determine the effectiveness of the method. In addition, in the method for manufacturing a coating film described in WO2006/063469, the film is mainly made of a fine-grained metal material and thus there is a problem in that a macromolecular coating film is not formed. In the method for manufacturing a macromolecular coating film using a warm spraying method described in Seiji KURODA, “The Basic and Application of the Warm Spraying Method”, SOKEIZAI, 2010, Vol. 51, No. 6, pp 14 to 19, the thickness of a film being formed is approximately several tens of micrometers, which is extremely thin.

The invention has been made in consideration of the above-described problems and an object of the invention is to provide powder for cold spray enabling the formation of a relatively thick macromolecular coating film using the cold spray method, a macromolecular coating film and a method for manufacturing a macromolecular coating film.

In order to achieve the above-described object, powder for cold spray according to the invention contains a mixture of powder of a macromolecule and nanoparticles of a ceramic.

When the powder for cold spray according to the invention is sprayed to a base material using a cold spray method, it is possible to form a coating film on the surface of the base material. When the nanoparticles of a ceramic are mixed with the powder of a macromolecule, the thickness of a film being formed reaches 1 mm or more and it is possible to form a relatively thick coating film. This is considered to be because the nanoparticles connect the interfaces between particles in the powder of the macromolecule. In addition, in the powder for cold spray according to the invention, it is possible to form an unoxidized coating film at a higher film formation rate compared with the spraying method by using a cold spray method. In addition, it is also possible to suppress the thermal alteration of the particles of the macromolecule.

The powder for cold spray according to the invention preferably includes nanoparticles mixed therein so that the powder is evenly attached to the surfaces of the particles of the macromolecule. Particularly, the mixture of powder of a macromolecule and nanoparticles of a ceramic preferably includes the nanoparticles in a range of 1% by mass to 10% by mass of the mixture. In this case, it is possible to thicken a coating film being formed. The mixture of powder of a macromolecule and nanoparticles of a ceramic includes the macromolecule in a range of 90% by mass to 99% by mass of the mixture. The powder for cold spray may also include additives such as pigments and/or dyeing agents for instance.

In the powder for cold spray according to the invention, the macromolecule is preferably an organic macromolecule, preferably a synthetic resin, and preferably a thermoplastic resin. The powder for cold spray may comprise a mixture of macromolecules. Within the powder for cold spray, the macromolecule has a particle size (preferably its diameter) that preferably ranges from 10 to 150 micrometers. The molecular weight of the macromolecule is preferably at least 1 million g/mol, more preferably at least 3 million g/mol. Examples of the preferred organic macromolecule include commodity plastics such as polyethylene (PE), high-density polyethylene (HDPE), medium-density polyethylene (MDPE), low-density polyethylene (LDPE), polypropylene (PP), polystyrene (PS), polyvinyl chloride (PVC), polyvinylidene chloride, polyvinyl acetate (PVAc), polyurethane, acrylonitrile-butadiene-styrene resins (ABS resins), acrylonitrile-styrene resins (AS resins), acrylic resins (polymethyl methacrylate (PMMA) and the like), and polytetrafluoroethylene (PTFE); engineering plastics such as polyacetal (POM), polyamide (PA), nylons, polycarbonate (PC), polyphenylene ether, modified polyphenylene ether (m-PPE, modified PPE, PPO), polybutylene terephthalate (PBT), polyethylene terephthalate (PET), glass fiber-reinforced polyethylene terephthalate (GFRP), polyethylene terephthalate glass resin (PET-G), ultrahigh molecular weight polyethylene, syndiotactic polystyrene, and cyclic polyolefin (COP); super engineering plastics such as amorphous polyarylate (PAR), polysulfone (PSF), polyethersulfone (PES), polyphenylene sulfide (PPS), polyether ether ketone (PEEK), polyimide, polyether imide, fluoro resins, liquid crystal polymers (LCP), polytetrafluoroethylene, thermoplastic polyimde (PI), and polyamideimide (PAI), and the like. In addition, the organic macromolecule is particularly preferably an ultrahigh molecular weight polyethylene. In these cases, it is possible to form a coating film having corrosion resistance, chemical resistance, and impact absorption characteristics. In a case in which the macromolecule is ultrahigh molecular weight polyethylene (UHMWPE), it is possible to form a coating film that is excellent particularly in terms of impact resistance or abrasion resistance. Since the ultrahigh molecular weight polyethylene has poor fluidity when melted, the injection molding thereof has been difficult, but the use of the cold spray method enables the easy formation of a coating film.

In the powder for cold spray according to the invention, any ceramic may be used as long as the ceramic is capable of fixing the particles of the macromolecule to each other, but the ceramic is particularly preferably an inorganic oxide, more preferably aluminum oxide. According to a particular embodiment, the ceramic may be silica. The powder for cold spray may comprise a mixture of nanoparticles of a ceramic. In a case in which the ceramic is made of preferably aluminum oxide, it is possible to increase, particularly, the fixing strength between the particles of the macromolecule, and a thick film having high strength can be formed.

In a method for manufacturing a macromolecular coating film according to the invention, the coating film is formed on the surface of the base material by spraying the powder for cold spray according to the invention to the base material using a cold spray method. The base material may be any suitable substrate, preferably a metal substrate, or a polymer substrate, or a composite substrate, or a ceramic substrate. For instance, the base material may be aluminum or polypropylene.

In a method for manufacturing a macromolecular coating film according to the invention, when the powder for cold spray according to the invention is used, it is possible to form a coating film having a relatively thick thickness of 1 mm or more.

Since the cold spray method is used, it is possible to form an unoxidized coating film at a higher film formation rate compared with the melt-spraying method. In addition, it is also possible to suppress the thermal alteration of the particles of the macromolecule.

A macromolecular coating film of the invention is obtained using the method for manufacturing a macromolecular coating film according to the invention. The invention also concerns a macromolecular coating film containing a mixture of powder of a macromolecule and nanoparticles of a ceramic according to the previous embodiments.

The thickness of the macromolecular coating film of the invention can be made to be relatively thick, that is, 1 mm or more. The thickness of the film preferably ranges from 1 mm to 10 mm, more preferably from 1 mm to 5 mm. Since the cold spray method is used, the macromolecular coating film according to the invention is formed at a higher film formation rate compared with the melt-spraying method. In addition, oxidization does not occur and the thermal alteration of the particles of the macromolecule is suppressed.

In a method for manufacturing a macromolecular molded product according to the invention, the powder for cold spray according to the invention sprayed to a base material or a mold using a cold spray method and then a molded product is obtained is removing it from the base material or the mold.

According to the method for manufacturing a macromolecular molded product according to the invention, it is possible to easily obtain a molecular molded product in which oxidization does not occur and the thermal denaturation is suppressed.

According to the invention, it is possible to provide powder for cold spray enabling the formation of a relatively thick macromolecular coating film using a cold spray method, a macromolecular coating film, and a method for manufacturing a macromolecular coating film.

FIG. 1 illustrates microscope photographs illustrating (a) alumina particles and (b) powders of ultrahigh molecular weight polyethylene (UHMWPE) which are contained in powders for cold spray of an embodiment of the invention, and (c) powders for cold spray of an embodiment of the invention.

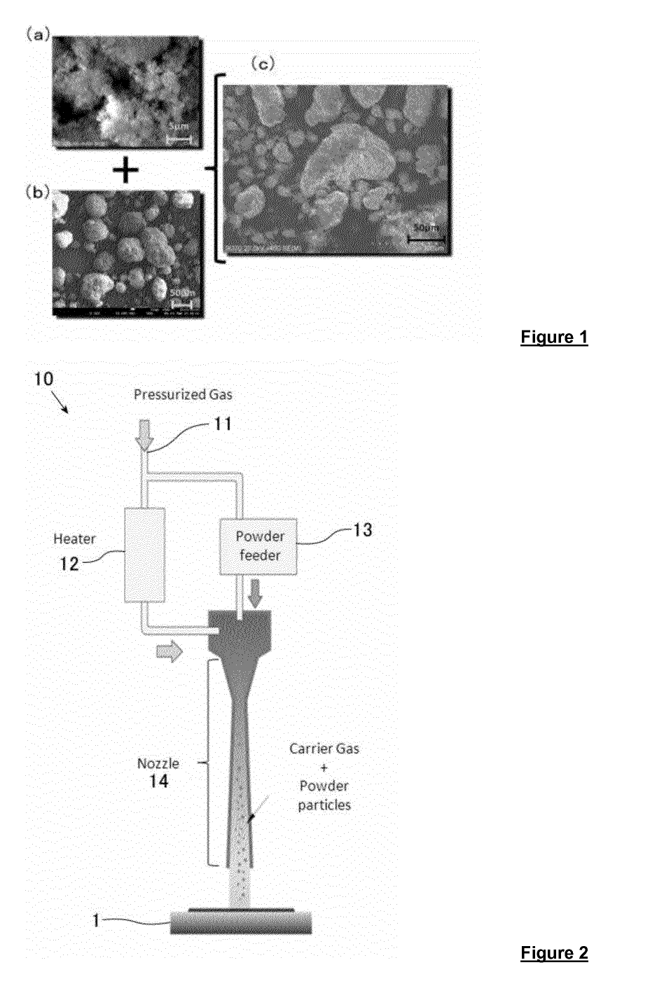

FIG. 2 is a side view illustrating a cold spray device for spraying the powders for cold spray of the embodiment of the invention to a base material.

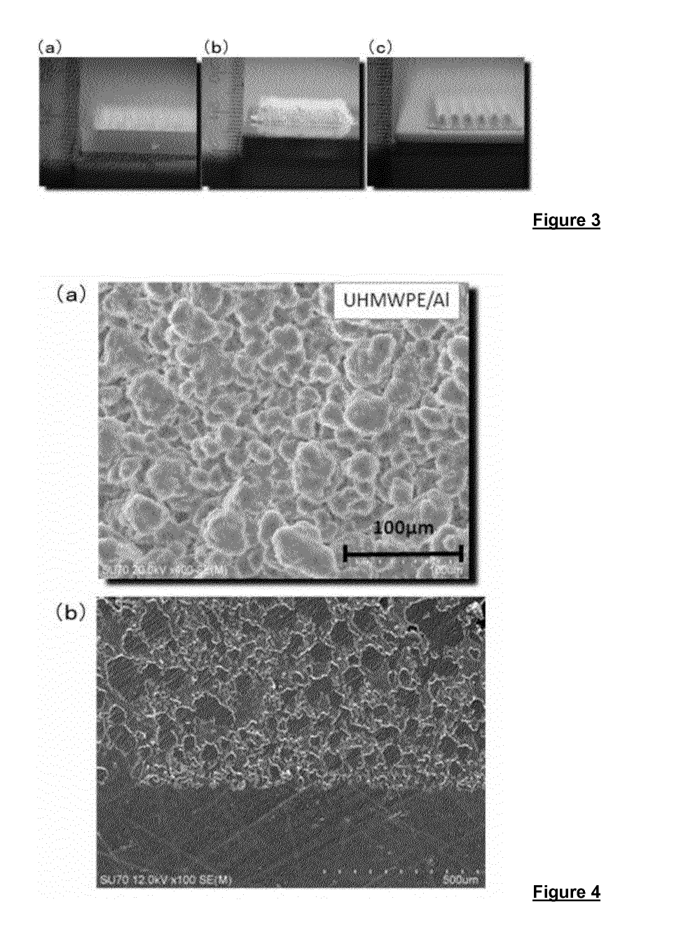

FIG. 3 illustrates perspective views illustrating macromolecular coating films formed by spraying the powder for cold spray of the embodiment of the invention to (a) a polypropylene base material, (b) a pure aluminum base material, and (c) an alumina base material using the cold spray device illustrated in FIG. 2.

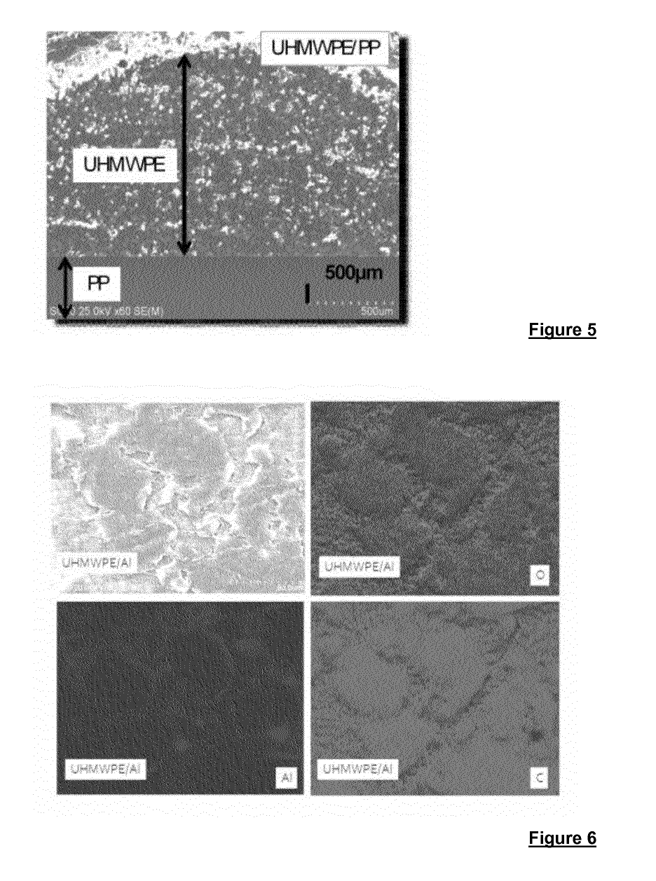

FIG. 4 illustrates (a) a scanning electron microscope (SEM) planar image and (b) a SEM cross-sectional image of the macromolecular coating film on the pure aluminum base material illustrated in FIG. 3(b).

FIG. 5 is a SEM cross-sectional image of the macromolecular coating film on the polypropylene base material illustrated in FIG. 3(a).

FIG. 6 illustrates a SEM planar image of the macromolecular coating film on the pure aluminum base material illustrated in FIG. 3(b) and energy dispersive X-ray spectroscopy (EDX) analyzed images of O, Al, and C.

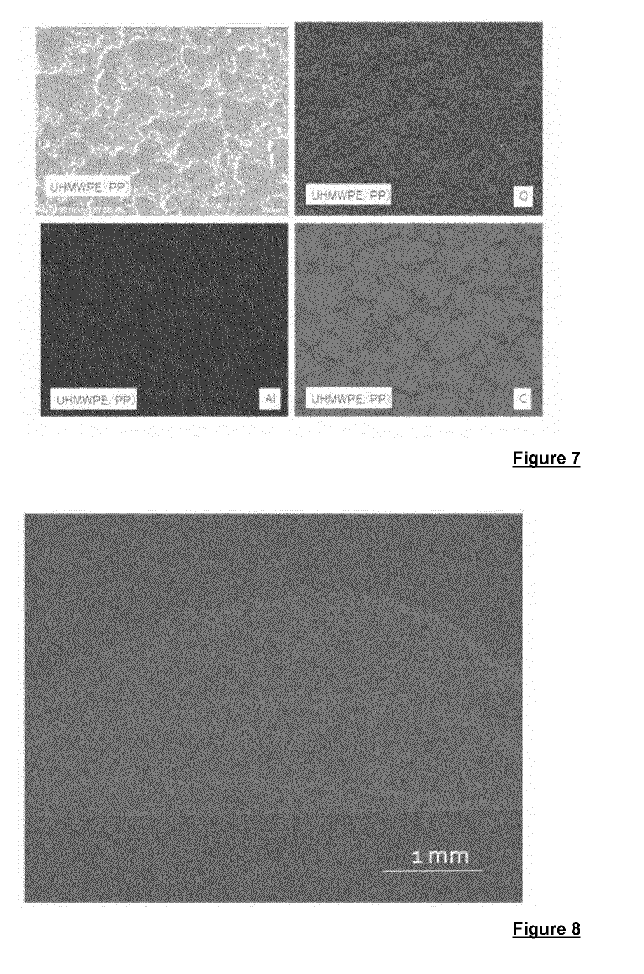

FIG. 7 illustrates a SEM planar image of the macromolecular coating film on the polypropylene base material illustrated in FIG. 3(b) and EDX analyzed images of O, Al, and C.

FIG. 8 is an EDX analyzed image of Al in a range of the SEM cross-sectional image of the macromolecular coating film on the polypropylene base material illustrated in FIG. 5.

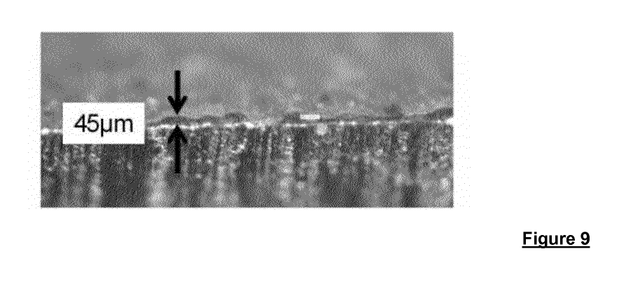

FIG. 9 is a microscope photograph illustrating a cross-section of the macromolecular coating film on the polypropylene base material of a comparative experiment in which only UHMWPE powder having a diameter in a range of 10 μm to 60 μm is sprayed.

Hereinafter, a film formation experiment was carried out using the powder for cold spray according to the invention. An embodiment of the invention will be described on the basis of the experiment results.

As powder for cold spray of the embodiment of the invention, a mixture of the powder of ultrahigh molecular weight polyethylene (UHMWPE) and ceramic nanoparticles made of alumina (aluminum oxide) particles was used. The UHMWPE powder has a molecular mass of 3900 kg/mol, a melting point in a range of 130° C. to 140° C., and a density of 0.940 g/cm³, and, as illustrated in FIG. 1(b), in the experiment, UHMWPE powder having a diameter in a range of 10 μm to 60 μm was used. In addition, as illustrated in FIG. 1(a), alumina particles having a diameter in a range of 40 nm to 90 nm was used. As illustrated in FIG. 1(c), powder obtained by adding 3.8% by mass of alumina particles to UHMWPE powder was used as the powder for cold spray.

In the experiment, the powder for cold spray was sprayed to the surface of a base material 1 by using a low-pressure type cold spray device 10 illustrated in FIG. 2. As illustrated in FIG. 2, the cold spray device 10 includes a gas feeding opening 11, a heater 12, a powder feeder 13, and a nozzle 14. The cold spray device 10 is constituted so that pressurized carrier gas fed from the gas feeding opening 11 is heated in the heater 12 and is sprayed from the tip of the nozzle 14 together with the powder for cold spray being fed from the powder feeder 13. In the experiment, the temperature of the carrier gas heated in the heater 12 was changed in a range of 100° C. to 250° C. and the pressure of the carrier gas was changed in a range of 0.2 MPa to 0.8 MPa. In addition, the length of the nozzle 14 was set to 200 mm. In addition, as the base material 1, a polypropylene base material (polymer base material), a pure aluminum base material (metal base material), and an alumina base material (ceramic base material) were used.

For comparison, experiments were carried out under the same conditions for a case in which only UHMWPE powder having a diameter in a range of 10 μm to 60 μm was sprayed in addition to a case in which the powder for cold spray of the embodiment of the invention and a case in which the length of the nozzle was set to 100 mm and only UHMWPE powder having a diameter in a range of 10 μm to 60 μm was sprayed.

FIG. 3 illustrates film formation states when the powder for cold spray of the embodiment of the invention was sprayed to the respective substrates using the cold spray method. As illustrated in FIG. 3, it was confirmed that an approximately 1 mm-thick macromolecular coating film was formed on the polypropylene base material, an approximately 4 mm-thick macromolecular coating film was formed on the pure aluminum base material, and an approximately 3 mm to 4 mm-thick macromolecular coating film was formed on the alumina base material. When sprayed to the polypropylene base material, the temperature of the carrier gas was 150° C. and the pressure thereof was 0.3 MPa. When sprayed to the pure aluminum base material and the alumina base material, the temperature of the carrier gas was 250° C. and the pressure thereof was 0.4 MPa.

A planar image and a cross-sectional image of the macromolecular coating film formed on the pure aluminum base material obtained using a scanning electron microscope (SEM) are illustrated in FIG. 4 and a SEM cross-sectional image of the macromolecular coating film formed on the polypropylene base material is illustrated in FIG. 5. In addition, a SEM planar image of the macromolecular coating film formed on the pure aluminum base material and the analyzed images of O, Al, and C in the planar image range obtained through energy dispersive X-ray spectroscopy (EDX) are illustrated in FIG. 6 and a SEM planar image of the macromolecular coating film formed on the polypropylene base material and the EDX analyzed images of O, Al, and C in the planar image range are illustrated in FIG. 7. In addition, FIG. 8 illustrates an EDX analyzed image of Al in the range of the SEM cross-sectional image on the polypropylene base material illustrated in FIG. 5. In the EDX analyzed images of O, Al, and C, portions with a large amount of each of the elements are displayed to be bright.

As illustrated in FIG. 4(a), it can be confirmed that the UHMWPE particles are deposited on the surface of the base material without being melted and form a film. In addition, as illustrated in FIGS. 4(b) and 5, it can be confirmed that the UHMWPE particles are tightly deposited on the surface of the base material. As illustrated in FIGS. 6 and 7, it can be confirmed that oxygen (O) is rarely observed on the surface of the formed coating film and the film is not oxidized. In addition, it can be confirmed that carbon (c) is observed on the surfaces of the particles and thus, the particles are the UHMWPE particles. In addition, as illustrated in FIGS. 6 to 8, it was observed that aluminum (Al) was distributed on the interfaces between the respective UHMWPE particles. From this observation, it can be considered that the alumina particles connect the interfaces between the respective UHMWPE particles and increase the strengths of adhesion between the respective particles.

As illustrated in FIG. 9, in the comparative experiment in which only UHMWPE powder having a diameter in a range of 10 μm to 60 μm was sprayed, it was confirmed that, in the case of the polypropylene base material being used, only one layer of a 45 μm-thick film was formed. In the pure aluminum base material and the alumina base material, the sprayed powder was bounded back on the surface of the base material and thus a film was rarely formed. In the experiments, the temperature of the carrier gas was in a range of 100° C. to 150° C. and the pressure thereof was in a range of 0.2 MPa to 0.8 MPa.

In the comparative experiment in which the length of the nozzle was set to 100 mm which was half of the length of the nozzle in the experiment and only UHMWPE powder having a diameter in a range of 10 μm to 60 μm was sprayed, it was not possible to form a film on any of the base materials. This is considered to be because the exposure time of the UHMWPE particles to a high-temperature gas in the nozzle was short.

From the above-described experiment results, the following facts were confirmed. That is, when the powder for cold spray of the embodiment of the invention, which is obtained by mixing the nanoparticles of alumina which is ceramic with the powder of the ultrahigh molecular weight polyethylene (UHMWPE), is sprayed to the base material using the cold spray method, it is possible to form a coating film having a relatively thick thickness of 1 mm or more on the surface of the base material. This is considered to be because the nanoparticles connect the interfaces between the particles in the powder of the macromolecule.

In addition, when the powder for cold spray of the embodiment of the invention is sprayed to the base material using the cold spray method, it is possible to form an unoxidized film at a higher film formation rate compared with the spraying method. In addition, it is also possible to suppress the thermal alteration of the particles of the macromolecule. Since the ultrahigh molecular weight polyethylene used had poor fluidity when melted, the injection molding thereof was difficult, but the use of the cold spray method enables the easy formation of a coating film. In addition, when the ultrahigh molecular weight polyethylene (UHMWPE) is used, it is possible to form a coating film that is excellent in terms of not only corrosion resistance or chemical resistance but, particularly, also impact resistance or abrasion resistance.

1. A powder for cold spray, comprising a mixture of powder of a macromolecule and nanoparticles of a ceramic.

2. The powder for cold spray according to claim 1, wherein nanoparticles represent from 1% by mass to 10% by mass of the mixture.

3. The powder for cold spray according to claim 1, wherein the macromolecule is an organic macromolecule having a molecular weight of at least 1 million g/mol.

4. The powder for cold spray according to claim 1, wherein the macromolecule is a thermoplastic resin.

5. The powder for cold spray according to claim 1, wherein the macromolecule is an ultrahigh molecular weight polyethylene.

6. The powder for cold spray according to claim 1, wherein the ceramic is aluminum oxide.

7. The powder for cold spray according to claim 1, wherein said powder comprises a mixture of ultrahigh molecular weight polyethylene and aluminum oxide.

8. A method for manufacturing a macromolecular coating film, said method comprising forming the film on a surface of a base material by spraying the powder for cold spray according to claim 1 on the base material using a cold spray method.

9. A macromolecular coating film obtained using the method for manufacturing a macromolecular coating film according to claim 8.

10. A macromolecular coating film comprising a mixture of powder of a macromolecule and nanoparticles of a ceramic.

11. The macromolecular coating film according to claim 10, wherein nanoparticles represent from 1% by mass to 10% by mass of the mixture.

12. The macromolecular coating film according to claim 10, wherein the macromolecule is an organic macromolecule having a molecular weight of at least 1M g/mol.

13. The macromolecular coating film according to claim 10, wherein the macromolecule is a thermoplastic resin.

14. The macromolecular coating film according to claim 10, wherein the macromolecule is an ultrahigh molecular weight polyethylene.

15. The macromolecular coating film according to claim 10, wherein the ceramic is aluminum oxide.

16. The macromolecular coating film according to claim 10, comprising a mixture of ultrahigh molecular weight polyethylene and aluminum oxide.

17. A method for manufacturing a macromolecular molded product, said method comprising spraying the powder for cold spray according to claim 1 on a base material or a mold using a cold spray method and then obtaining a molded product by removing it from the base material or the mold.

18. The powder for cold spray according to claim 2, wherein the macromolecule is an organic macromolecule having a molecular weight of at least 1 million g/mol.

19. The powder for cold spray according to claim 18, wherein the macromolecule is a thermoplastic resin.

20. The powder for cold spray according to claim 19, wherein the macromolecule is an ultrahigh molecular weight polyethylene and the ceramic is aluminum oxide.
